(19) United States
(12) Patent Application Publication
(10) Pub. No.: US 2020/0041037 A1
(43) Pub. Date: Feb. 6, 2020

(54) STABILIZED PIPE SYSTEM AND PIPE STABILIZATION APPARATUS

(71) Applicant: Perry R. Wherley, Chino Valley, AZ (US)

(72) Inventor: Perry R. Wherley, Chino Valley, AZ (US)

(21) Appl. No.: 16/510,562

(22) Filed: Jul. 12, 2019

Related U.S. Application Data
(60) Provisional application No. 62/714,904, filed on Aug. 6, 2018.
(60) Provisional application No. 62/770,308, filed on Nov. 21, 2018.

(51) Int. Cl. F16L 1/06; F16L 3/10

(52) U.S. Cl. CPC F16L 1/06; E03B 9/02; F16L 3/1016

(57) ABSTRACT

A pipe stabilization apparatus is described that stabilizes a pipe partially buried in the ground, such as a plumbing pipe of a yard water hydrant or a gas riser pipe. The pipe is stabilized so that forces and stress on a part of the pipe that extends above ground will not cause pipe breakage or leaks in the pipe or pipe connections that are below ground. The pipe stabilization apparatus includes a first arm coupled to a first clamp, and a second arm coupled to a second clamp. The first and the second clamps are coupled to each other, with the pipe in between, so that the first and the second arm extend from the pipe. A first end of the pipe, the two clamps coupled to the pipe, and the two arms are buried underground with a second end of the pipe extending out of the ground.

### CROSS REFERENCE TO RELATED APPLICATION

This application claims priority to U.S. provisional patent application Ser. No. 62/714,904, filed Aug. 6, 2018 and entitled “Outdoor Pipe Stabilizer”, which is incorporated entirely herein by reference. This application also claims priority to U.S. provisional patent application Ser. No. 62/770,308, filed Nov. 21, 2018 and entitled “Pipe Stabilization Apparatus”, which is incorporated entirely herein by reference.

### BACKGROUND OF THE INVENTION

### Technical Field

This invention relates to outdoor plumbing and, specifically, to a pipe stabilization apparatus for use with pipes that partially extend out of the ground such as a yard water hydrant water pipe or a gas riser pipe.

### State of the Art

Outdoor plumbing includes pipes for carrying water, fluids, or gases, for example, in outdoor environments. Examples of outdoor plumbing include a yard water hydrant and a gas riser pipe. A yard water hydrant includes a water pipe having a water spigot attached to one end of the pipe and a valve attached to the other end of the pipe. The valve end of the water pipe, opposite the water spigot, is connected to an underground water line. The water spigot end of the water pipe extends above the ground. The water spigot is used to provide water in an outdoor environment. The yard water hydrant is often not connected to a building or structure and is subject to forces such as people pulling garden hoses around the pipe, or animals putting pressure on the pipe, which can cause the pipe to bend or break underground at the connection to the water line.

The gas riser pipe is a pipe for transporting gas. One end of the gas riser pipe is underground and can be coupled to a gas line. The other end of the gas riser pipe is above ground and can be capped or be coupled to a gas receiver. The aboveground portion of the gas riser pipe can also be subject to forces that can bend or break the gas line, or the underground gas pipe connections.

It is advantageous to have an apparatus to stabilize a pipe to make it less likely to bend or break at underground water or gas connections, which could cause flooding or gas leaks. It is also advantageous to have an apparatus to assist in the installation of the pipe by holding the pipe in an upright position while an installer makes the underground connections, lays gravel and backfills the hole.

### BRIEF DESCRIPTION OF THE DRAWINGS

FIG. 1 shows a stabilized pipe system that includes a yard water hydrant and a pipe stabilization apparatus;

FIG. 2 shows a close-up side perspective view of the pipe stabilization apparatus of FIG. 1;

FIG. 3 shows a yard water hydrant kit that includes a yard water hydrant and a pipe stabilization apparatus;

FIG. 4 shows a further embodiment of a stabilized pipe system;

FIG. 5 shows a further embodiment of a pipe stabilization apparatus;

FIG. 6 shows an additional embodiment of a pipe stabilization apparatus;

FIG. 7 shows a close-up top view of a pipe stabilization apparatus;

FIG. 8 shows another embodiment of a pipe stabilization apparatus;

FIG. 9 shows an embodiment of a stabilized pipe system that includes a gas riser pipe and a pipe stabilization apparatus; and

FIG. 10 shows a method of stabilizing a pipe.

### DETAILED DESCRIPTION OF EMBODIMENTS OF THE INVENTION

The invention described herein relates to outdoor plumbing and, specifically, to a pipe stabilization apparatus for use with pipes that partially extend out of the ground such as a yard water hydrant water pipe or a gas riser pipe. Disclosed is a stabilized pipe system that includes a pipe and a pipe stabilization apparatus. The pipe is partially buried underground. The pipe stabilization apparatus stabilizes the pipe so that the portion of the pipe extending out of the ground can handle forces and stress without breaking the underground pipe connections. The pipe stabilization apparatus includes a first and a second clamp. Each clamp has an arm extending from the clamp. The first and the second clamps are coupled to the pipe of the stabilized pipe system in a position on the pipe that will be underground once installation is complete. Once the first and the second clamps are coupled to the pipe, the arms extend away from the pipe, often perpendicular to the pipe. The pipe and the pipe stabilization apparatus are buried underground. Once the stabilized pipe system is fully installed, the pipe stabilization apparatus is underground, and the arms coupled to the pipe are buried in dirt. The arms coupled to the pipe provide stability to the pipe, holding the pipe in place in the ground so that forces and stress on the pipe do not transfer to stress on the underground connections.

In a yard water hydrant system, a water line extends underground from a water source to a water delivery location. A yard water hydrant includes a water pipe with a valve at one end of the water pipe and a spigot at the other end of the water pipe. The valve end of the water pipe is fluidly coupled to an underground water line at the water delivery location. The water pipe of the yard water hydrant extends upright (vertically) out of the ground, with the valve end of the pipe buried underground and the spigot end above ground. The spigot is used to supply water at the water delivery location. The yard water hydrant can be subject to forces that put stress on the pipe, causing the pipe to move and put stress on the underground pipe connections. These forces on the water pipe include, but are not limited to, humans dragging water hoses alongside the water pipe, pushing and pulling of the water pipe with a hose, and animals leaning on the water pipe. The stress on the underground connections can cause breakage of the connections or the pipes, which causes flooding and water waste. The disclosed pipe stabilization apparatus stabilizes the pipe so that breakage of the underground connections does not occur. The disclosed pipe stabilization apparatus can also be used to hold the pipe in place as the stabilized pipe system is installed and dirt or rocks are backfilled around the underground pipe and pipe connections.

In a gas delivery system, a gas line extends underground from a gas source to a gas delivery location. A gas riser pipe system delivers the gas from the underground gas line to an aboveground connection. A gas riser pipe system can include a gas pipe with a valve or other connection to a gas pipe at one end of the gas pipe and a cap at the other end of the gas pipe, or a connection to a gas receiving apparatus. The gas pipe connection end of the gas pipe is coupled to the underground gas line at the gas delivery location. The gas pipe of the gas riser pipe system extends upright (usually vertically) out of the ground, with the valve/gas pipe connection end of the pipe buried underground and the cap end above ground. The cap end is used to supply gas at the gas delivery location. The gas riser pipe can be subject to forces that put stress on the pipe, causing the pipe to move and put stress on the underground pipe connections. The stress on the underground connections can cause breakage of the connections or the pipes, which causes dangerous gas leaks. The disclosed pipe stabilization apparatus stabilizes the gas pipe so that breakage of the underground connections does not occur. The disclosed pipe stabilization apparatus can also be used to hold the gas pipe in place as the stabilized pipe system is installed and dirt or rocks are backfilled around the underground gas pipe and pipe connections.

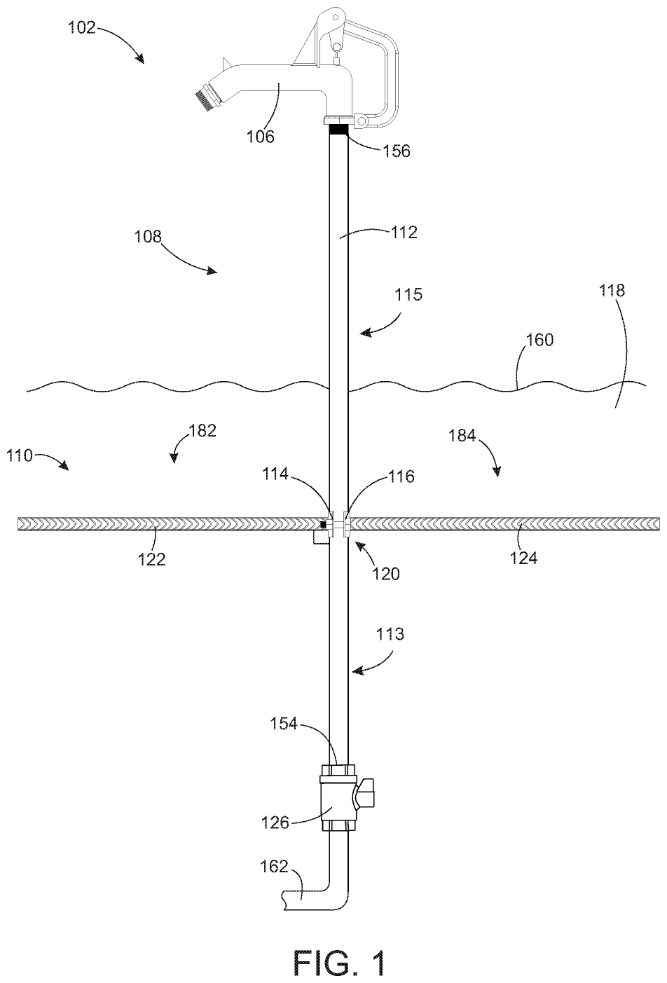

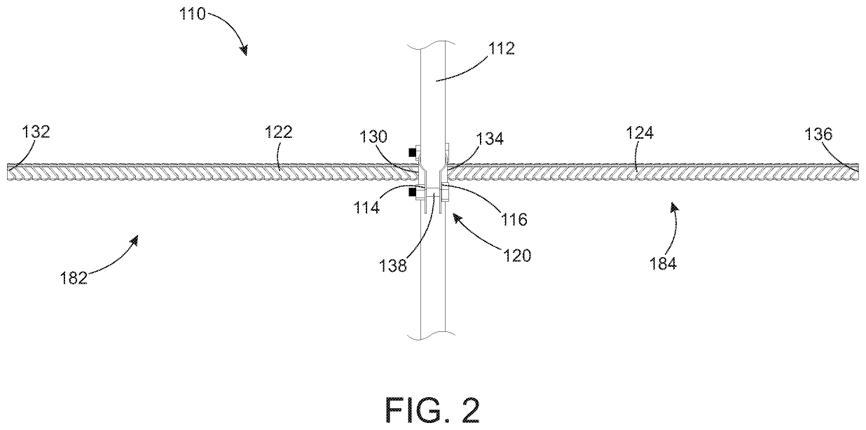

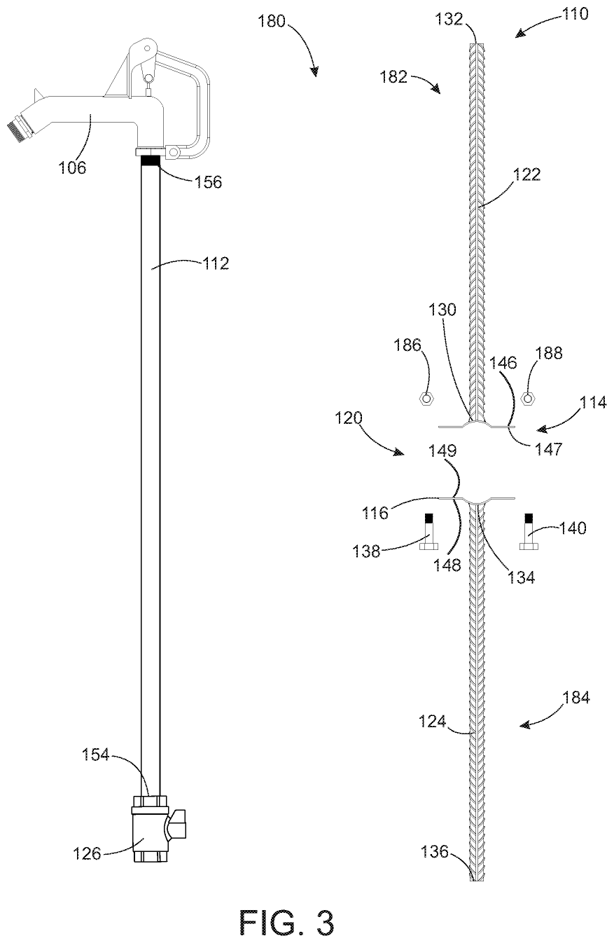

FIG. 1 through FIG. 3 show details of a stabilized pipe system 102 that includes a yard water hydrant 108 and a pipe stabilization apparatus 110. FIG. 1 shows a side view of stabilized pipe system 102 and pipe stabilization apparatus 110 as installed in ground 118. FIG. 2 shows a close-up side perspective view of pipe stabilization apparatus 110 of FIG. 1 with ground 118 not shown for clarity. FIG. 3 shows the components of a yard water hydrant kit 180 that includes yard water hydrant 108 and pipe stabilization apparatus 110.

Stabilized pipe system 102 includes yard water hydrant 108 and pipe stabilization apparatus 110, as shown in FIG. 1 through FIG. 3. Yard water hydrant 108 includes a water pipe 112 having a pipe first end 154 and a pipe second end 156 opposing pipe first end 154, see FIG. 1 and FIG. 3. Yard water hydrant 108 includes a water valve 126 coupled to pipe first end 154 in this embodiment, and a spigot 106 coupled to pipe second end 156. In some embodiments, yard water hydrant 108 does not include water valve 126 or spigot 106. Yard water hydrant 108 is installed so that water pipe 112 is upright, extending essentially vertically out of ground 118. A bottom portion 113 of water pipe 112 is buried underground, with valve 126 coupled to a water line 162, see FIG. 1. Pipe first end 154 and bottom portion 113 are buried below a ground surface level 160. “Below ground surface level 160” means buried in ground 118, or underground, in this document, and “above ground surface level 160” means aboveground, not buried in ground 118. Bottom portion 113 extends from valve 126 to ground surface level 160. Water line 162 is a water pipe that is coupled to a water source and delivers water to yard water hydrant 108. Water line 162, valve 126, bottom portion 113 of pipe 112, and pipe stabilization apparatus 110 are buried in ground 118.

An upper portion 115 of water pipe 112, and spigot 106 are above ground surface level 160 of ground 118. Pipe second end 156, upper portion 115, and spigot 106 are above ground surface level 160. Upper portion 115 extends from ground surface level 160 to spigot 106. Water spigot 106 is used to turn on and off the flow of water from yard water hydrant 108. Yard water hydrant 108 is used to provide water in a yard, often away from buildings or other structures. Yard water hydrant 108 can be used to water animals or gardens, for example. A water hose is often connected to spigot 106 for above-ground water delivery.

Yard water hydrants such as yard water hydrant 108 are known for breakage of the underground pipes or water connections, such as pipe 162 or the connection at valve 126, due to movement of water pipe 112. Water pipe 112 can be moved by people dragging hoses around them, or pulling on hoses attached to spigot 106, for example. Or, if yard water hydrant 108 is installed in an animal pen, for example, the animals may lean on yard water hydrant 108, which can also cause breakage of the underground pipes or connections. Once pipe 162 or the connection of yard water hydrant 108 to pipe 162 breaks, water leakage and flooding can occur and the connections need to be dug up and fixed.

Pipe stabilization apparatus 110 described herein stabilizes water pipe 112 so that forces or stress put on upper portion 115 of water pipe 112 from aboveground do not transfer as stress on the underground connections. Pipe stabilization apparatus 110 is attached to pipe 112 so that once installation of yard water hydrant 108 is complete, pipe stabilization apparatus 110 is buried under ground surface level 160 in ground 118 with pipe first end 154, bottom portion 113 of water pipe 112 and valve 126, see FIG. 1. Forces and stress applied to upper portion 115 of stabilized pipe system 102 do not transfer to the underground water connections because pipe stabilization apparatus 110 holds pipe 112 in place in ground 118.

Pipe stabilization apparatus 110 is also useful in holding water pipe 112 in place as yard water hydrant 108 is installed. To install yard water hydrant 108, a hole is dug down to water line 162. Water line 162 is connected (fluidly coupled) to water pipe 112, usually at valve 126, so that water flows into pipe 112 of yard water hydrant 108 from water line 162. The hole is then filled in, often using rock or gravel and then dirt. Until there is enough dirt in the hole to keep pipe 112 upright, water pipe 112 can tip or fall over during installation, causing pipe breakage or stress. Pipe stabilization apparatus 110, however, can be stuck into the sides of the hole to keep water pipe 112 upright while sand, gravel, and/or dirt is used to fill the hole and bury water line 162, valve 126, pipe stabilization apparatus 110, pipe first end 154, and bottom portion 113 of water pipe 112.

FIG. 1 shows a side view of stabilized pipe system 102 including yard water hydrant 108 and pipe stabilization apparatus 110, after installation is complete. FIG. 2 shows a close-up view of pipe stabilization apparatus 110 with no dirt shown for ease of viewing pipe stabilization apparatus 110. Pipe stabilization apparatus 110 is shown being used with yard water hydrant 108 in this embodiment, but this is not meant to be limiting. It is to be understood that pipe stabilization apparatus 110 can be used with many different type of underground pipes, or pipes embedded in material other than the ground and carrying any type of fluid or gas or other flowing substance.

Pipe stabilization apparatus 110 includes a first and a second clamp 114 and 116, and a first and a second arm 122 and 124, see FIG. 1 through FIG. 3. First and second clamps 114 and 116 are saddle clamps in this embodiment, but this is not meant to be limiting. First and second clamps 114 and 116 can be any type of clamp or coupler that couples arms 122 and 124 to water pipe 112. A clamp coupler 120 couples first clamp 114 to second clamp 115 with pipe 112 in between, in the embodiment show in FIG. 1 and FIG. 2. In the embodiment shown in FIG. 1 and FIG. 2, clamp coupler 120 is a pair of brass bolts 138 and 140 and nuts 186 and 188 (see FIG. 3), but this is not meant to be limiting. First and second clamps 114 and 116 are each coupled to pipe 112 below ground surface level 160 once pipe stabilization apparatus 110 is fully installed.

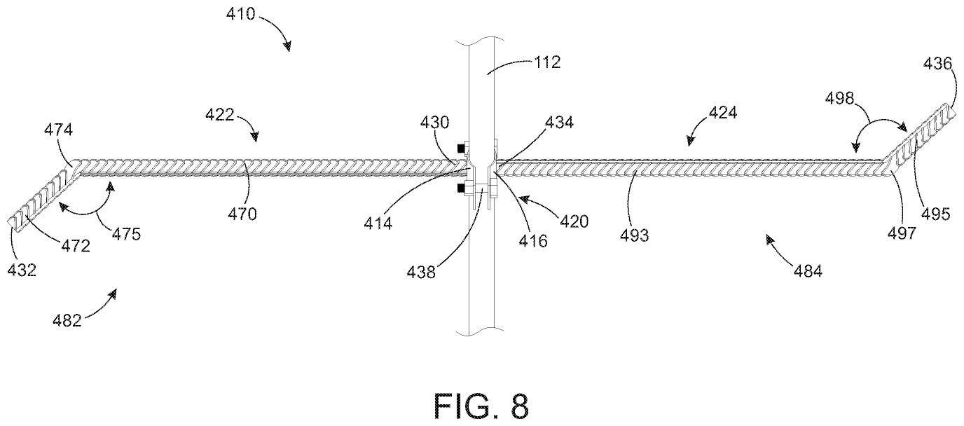

First and second arm 122 and 124 are each elongate bars of rigid material. In this embodiment, first and second arm 122 and 124 are bars of rebar with a circular cross-section, but this is not meant to be limiting. First and second arm 122 and 124 can be elongate bars or rods of many different types of rigid material, such as metal, plastic, or wood, for example, and can have many different shapes and cross-sectional shapes. First and second arm 122 and 124 have a length of about 10 inches in this embodiment, but that is not meant to be limiting. First and second arm 122 and 124 can have length from about 5 inches to about 40 inches. These lengths have been found to be easy to install and hold pipe 112 firmly in ground 118 once installed. First and second arm 122 and 124 each have the same length in this embodiment, but this is not meant to be limiting. In some embodiments, first and second arm 122 and 124 have different lengths. First and second arm 122 and 124 are straight in this embodiment, but this is not meant to be limiting. In some embodiments (see FIG. 8 and the accompanying description, for example), first or second arm 122 or 124 have one or more bends in them.

First and second arm 122 and 124 are coupled to water pipe 112 using first and second clamps 114 and 116, and clamp coupler 120. First arm 122 includes a first arm proximal end 130 and a first arm distal end 132 opposing first arm proximal end 130, see FIG. 2 and FIG. 3. First arm proximal end 130 is coupled to first clamp 114. First arm proximal end 130 of first arm 122 is coupled to first clamp 114 such that when first clamp 114 is coupled to water pipe 112, first arm 122 extends perpendicular to pipe 112.

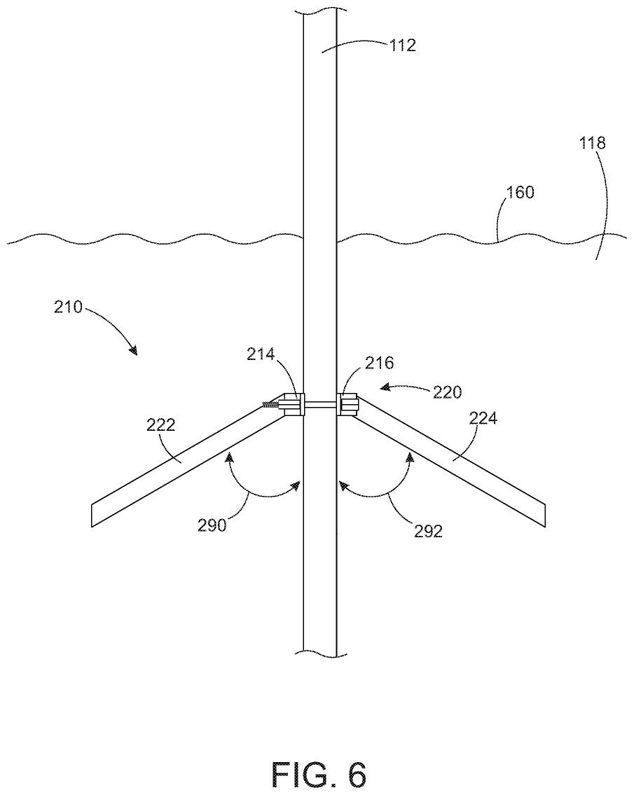

Second arm 124 includes a second arm proximal end 134 and a second arm distal end 136 opposing second arm proximal end 134, see FIG. 2 and FIG. 3. Second arm proximal end 134 is coupled to second clamp 116. Second arm proximal end 134 of second arm 124 is coupled to second clamp 116 such that when second clamp 116 is coupled to pipe 112, second arm 124 extends perpendicular to pipe 112. First and second arm 122 and 124 are perpendicular to water pipe 112 once first and second clamp 114 and 116 are coupled to pipe 112, in this embodiment, but this is not meant to be limiting. In some embodiments, first and second arm 122 or 124 form an angle other than 90 degrees between first or second arm 122 or 124, and water pipe 112. See, for example, FIG. 6 and the accompanying description.

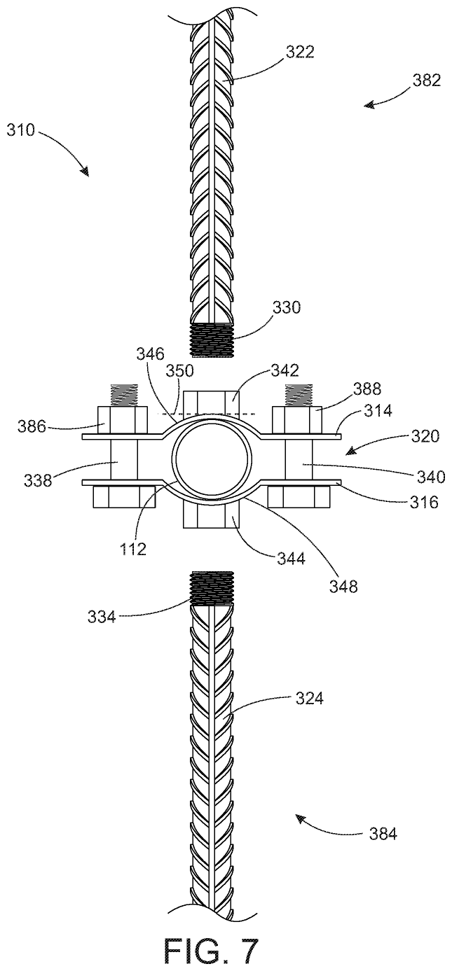

First and second clamp 114 and 116 are each formed of an elongate bar with a bolt hole through each end and a bend in the middle to partially encircle water pipe 112, see FIG. 1 through FIG. 3. First arm 122 is coupled to an outer surface 146 of first clamp 114 (FIG. 3). First arm 122 is coupled to outer surface 146 of first clamp 114 so that when first clamp 114 is coupled to water pipe 112 with an inner surface 147 of first clamp 114 against water pipe 112, first arm 122 extends outwards perpendicularly from water pipe 112. In this embodiment, first arm 122 is coupled to first clamp 114 such that first arm 122 is perpendicular to a tangent line of first clamp 114. First arm proximal end 130 of first arm 122 is welded to first clamp 114 in this embodiment, but this is not meant to be limiting. First and second arm 122 and 124 can be coupled to first and second clamp 114 and 116 using any type of coupling. See, for example, FIG. 7 and the accompanying description. First arm 122 is coupled to first clamp 114 about halfway between the two ends of the elongate bar forming first clamp 114, in this embodiment, but this is not meant to be limiting. First arm 122 can be coupled to first clamp 114 at many different locations along first clamp 114.

Second arm 124 is coupled to an outer surface 148 of second clamp 116, see FIG. 1 through FIG. 3. Second arm 124 is coupled to outer surface 148 of second clamp 116 so that when second clamp 116 is coupled to water pipe 112 with an inner surface 149 of second clamp 116 against water pipe 112, second arm 124 extends outwards perpendicularly from water pipe 112. In this embodiment, second arm 124 is coupled to second clamp 116 such that second arm 124 is perpendicular to a tangent line of second clamp 116. Second arm 124 is welded to second clamp 116 in this embodiment, but this is not meant to be limiting. Second arm 124 is coupled to second clamp 116 about halfway between the two ends of the elongate bar forming second clamp 116, in this embodiment, but this is not meant to be limiting. Second arm 124 can be coupled to second clamp 116 at many different locations along second clamp 116.

With first arm 122 coupled to first clamp 114 and second arm 124 coupled to second clamp 116, first and second clamp 114 and 116 are coupled to pipe 112 using a clamp coupler 120, as shown in FIG. 1 through FIG. 3. Clamp coupler 120 includes two bolts 138 and 140 and two nuts 186 and 188, best seen in FIG. 3. In this embodiment, bolts 138 and 140 are brass bolts, but bolts 138 and 140 can be made of any suitable material. Each bolt 138 and 140 extend through bolt holes in each of first clamp 114 and second clamp 116 once first and second clamps 114 and 116 are placed over water pipe 112, so that water pipe 112 is between first and second clamp 114 and 116. Bolt 138 extends through a first hole in first clamp 114 and a first hole in second clamp 116. Bolt 140 extends through a second hole in first clamp 114 and a second hole in second clamp 116. Nuts 186 and 188 are put on bolts 138 and 140 to couple first and second clamps 114 and 116 together around water pipe 112, see FIG. 1 and FIG. 2. First clamp 114 is coupled to second clamp 116 using clamp coupler 120, with pipe 112 in between. It is to be understood that clamp coupler 120 can be replaced with many different types of couplers for coupling first and second clamp 114 and 116 to pipe 112.

Clamp coupler 120 couples first and second clamp 114 and 116, and first and second arm 122 and 124, to pipe 112. First and second arm 122 and 124 are coupled to pipe 112 such that they extend perpendicularly to pipe 112, in the embodiment shown in FIG. 1 through FIG. 3. First and second arm 122 and 124 are colinear in this embodiment, but this is not meant to be limiting. First and second arm 122 and 124 are colinear in response to first clamp 114 being coupled to second clamp 116. In some embodiments, first and second arm 122 and 124 are not colinear, see FIG. 6 and the accompanying description, for example.

In the embodiment shown in FIG. 1 through FIG. 3, clamp coupler 120 couples both first and second clamp 114 and 116 to pipe 112. In some embodiments, first clamp 114 and second clamp 116 are not coupled to pipe 112 using the same clamp coupler. In some embodiments, first clamp 114 and first arm 122 are coupled to pipe 112 with a first coupler at a first location on pipe 112, and second clamp 116 and second arm 124 are coupled to pipe 112 using a second coupler at a second location on pipe 112. The first coupler and the second coupler can couple first and second clamp 114 and 116 to pipe 112 at different locations on pipe 112. This construction can be useful if there are obstructions in the ground, for example, that make it difficult for first arm 122 and second arm 124 to be colinear in the installation.

In some embodiments, only one clamp 114 or 116 and one arm 122 or 124 are used on pipe 112. In some embodiments, three or more clamps and three or more arms are coupled to pipe 112. The number of clamps and arms and their configuration can be chosen based on the underground situation and the amount of stabilization needed for pipe 112.

FIG. 3 illustrates a yard water hydrant kit 180, which includes the components of stabilized pipe system 102 of FIG. 1 and FIG. 2, including yard water hydrant 108, a first stabilizer arm assembly 182, a second stabilizer arm assembly 184, and a clamp coupler 120. Yard water hydrant 108 includes pipe 112, spigot 106 coupled to second end 156 of pipe 112, and valve 126 coupled to first end 154 of pipe 112. First stabilized arm assembly 182 includes first clamp 114 and first arm 122 coupled to first clamp 114. Second stabilizer arm assembly 184 includes second clamp 116 and second arm 124 coupled to second clamp 116. Clamp coupler 120 couples first clamp 114 to second clamp 116 with pipe 112 in between. In this embodiment, clamp coupler 120 includes two bolts 138 and 140, and two nuts 186 and 188. Selling yard water hydrant kit 180 with all the components of stabilized pipe system 102 makes it easier for the consumer to get the correct components, and all of the components needed, to install stabilized pipe system 102.

When installing stabilized pipe system 102, a hole is dug in ground 118 to expose water line 162. In some installations, water line 162 is being installed at the same time, and this installation can occur first. Often valve 126 is coupled to underground water line 162, and then first clamp 112, second clamp 114, and first and second arm 122 and 124 are coupled to pipe 112. In some situations, first clamp 112, second clamp 114, and first and second arm 122 and 124 are coupled to pipe 112 first, and then valve 126 is coupled to water line 162. Ground 118 is then filled in to bury valve 126, pipe first end 154 and pipe stabilization apparatus 110, leaving pipe second end 156 and spigot 106 extending out of ground 118 above ground surface level 160. Pipe stabilization apparatus 110 can be used to hold pipe 112 in place as valve 126, pipe first end 154 and pipe stabilization apparatus 110 are covered with dirt and/or gravel or other fill material. Once stabilized pipe system 102 is installed, first and second arm 122 and 124 stabilize pipe 112 by friction between first and second arm 122 and 124 and ground 118. First and second arm 122 and 124 are very difficult to move in ground 118. First and second arm 122 and 124 make pipe 112 difficult to move back and forth. Stresses and forces on spigot 106 and upper portion 115 of pipe 112 are not transferred to valve 126 and the underground connections to water line 162, because first and second arm 122 and 124 hold pipe 112 in place in ground 118.

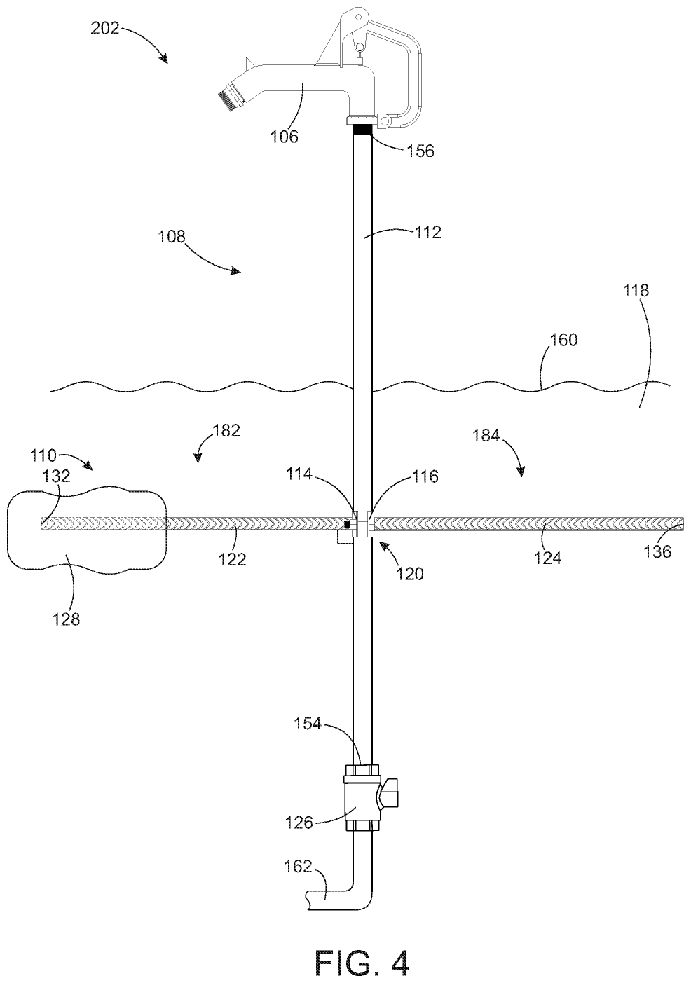

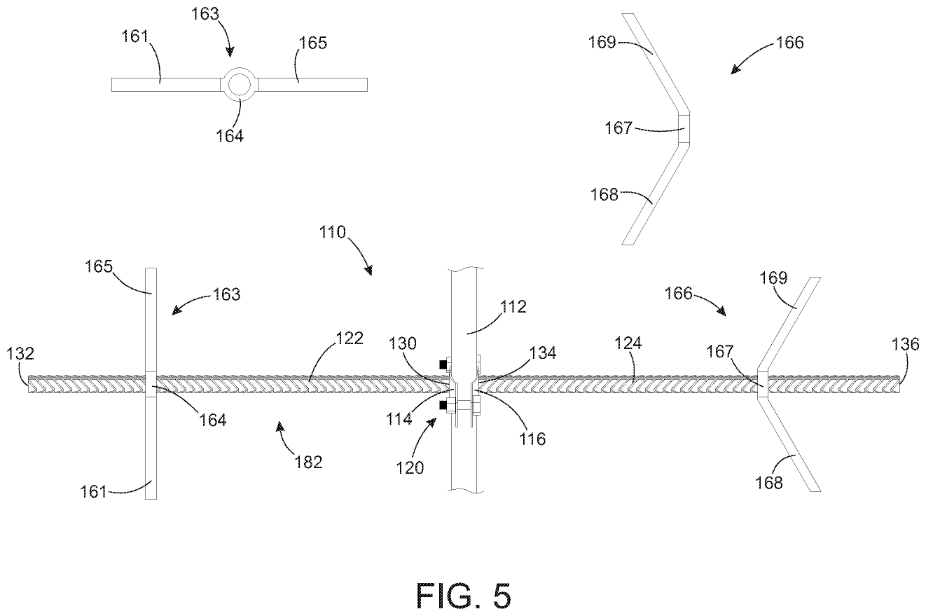

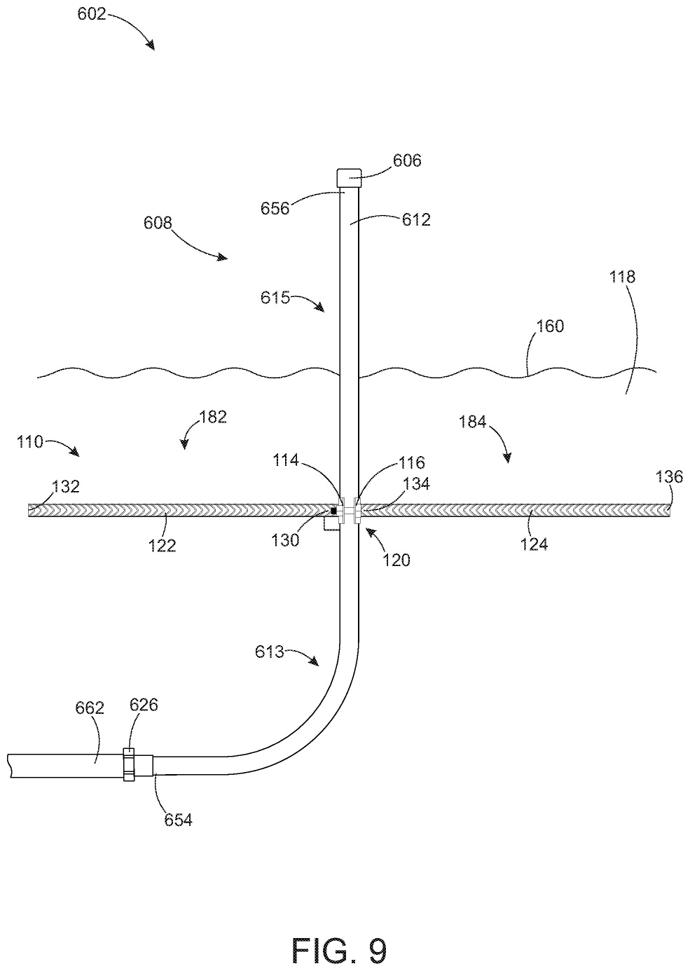

First and second arm 122 and 124 can have many different configurations, features and connections to first and second clamp 114 and 116 and pipe 112. FIG. 4 through FIG. 8 show further embodiments of stabilized pipe systems and pipe stabilization apparatus. FIG. 4 shows an embodiment of a stabilized pipe system 202. FIG. 5 shows an additional embodiment of pipe stabilization apparatus 110. FIG. 6 shows an embodiment of a pipe stabilization apparatus 210. FIG. 7 shows an embodiment of a pipe stabilization apparatus 310. FIG. 8 shows an embodiment of a pipe stabilization apparatus 410. FIG. 9 shows an embodiment of a stabilized pipe system 602.

FIG. 4 shows an embodiment of stabilized pipe system 202 that includes yard water hydrant 108 and pipe stabilization apparatus 110. Stabilized pipe system 202 is the same as stabilized pipe system 102 except that in stabilized pipe system 202, pipe stabilization apparatus 110 has first arm distal end 132 embedded in a concrete slab 128. Concrete slab 128 is buried in ground 118 underneath (below) ground surface level 160. Concrete slab 128 is poured around first arm distal end 132 during installation. Or, alternatively, concrete slab 128 can be poured and first arm distal end 132 stuck into concrete slab 128 during installation while concrete slab 128 is still wet. Concrete slab 128 makes first arm 122 even harder to move, which gives even more stability to pipe 112. The more immoveable first and second arm 122 and 124 are, the more stability they add to pipe 112, making pipe 112 immovable and less likely to bend and break at valve 126 or other underground connections. Concrete slab 128 can be made bigger or smaller for more or less stability. In some embodiments, second arm distal end 136 is also embedded in a concrete slab.

In some embodiments of pipe stabilization apparatus 110, other features or elements are attached to first or second arm 122 or 124 to make them more stable and less moveable in ground 118. FIG. 5 shows an example of stability attachments 163 and 166 attached to first and second arm 122 and 124 of pipe stabilization apparatus 110. Stability attachment 163 is coupled to first arm 122, in this embodiment, as shown in FIG. 5. Stability attachment 163 includes a ring 164 that encircles first arm 122 and is coupled to first arm 122 by any suitable method, including using set screws, for example, or welding. Stability attachment 163 also includes two tines 161 and 165 extending from ring 164. Tines 161 and 165 are colinear in this embodiment, but this is not meant to be limiting. Each of tines 161 and 165 are elongate rods or bars of rigid material with one end coupled to ring 164. Tines 161 and 165 are straight in this embodiment, but this is not meant to be limiting. Tines 161 or 165 can have curves or bends in them. In the embodiment of stability attachment 163 shown in the figures, once stability attachment 163 is coupled to first arm 122, tines 161 and 165 extend out perpendicularly from first arm 122, as shown in FIG. 5.

Stability attachment 166 includes a ring 167, which encircles and is coupled to second arm 124 by any suitable method. Stability attachment 166 also includes tines 168 and 169. Ring 167 can be coupled to second arm 124 in many ways, including screws, set screws, welding, for example. Tines 168 and 169 extend from ring 167. Tines 168 and 169 are elongate bars or rods of rigid material, with one end attached to ring 167. Tines 168 and 169 are straight in this embodiment, but this is not meant to be limiting. Tines 168 or 169 can have curves or bends in them. Tines 168 and 169 are not colinear in this example. Once stability attachment 166 is coupled to second arm 124, tines 168 and 169 extend non-perpendicularly from second arm 124.

Stability attachments 163 and 166 add frictional area to first arm 122 in ground 118, making it more difficult to move arms 122 or 124 in ground 118, which makes pipe 112 more stable. Stability attachments 163 and 165 can be used in many different positions and quantities on first arm 122 or second arm 124 to add stability to pipe 112. Tines 161, 165, 168, and 169 can be different sizes and lengths to provide the stability needed for pipe 112 in a particular installation.

FIG. 6 shows an embodiment of a pipe stabilization apparatus 210 used on pipe 112. Pipe stabilization apparatus 210 is similar to pipe stabilization apparatus 110, can be used in place of pipe stabilization apparatus 110, and has similar numbers for similar items. Pipe stabilization apparatus 210 is replacing pipe stabilization apparatus 110 on pipe 112 in the embodiment shown in FIG. 6. Pipe stabilization apparatus 210 includes a first clamp 214 and a second clamp 216 that are coupled to water pipe 112 using a clamp coupler 220. A first arm 222 is coupled to first clamp 214 so that when first clamp 214 is coupled to pipe 112, first arm 222 forms a first arm angle 290 between first arm 222 and water pipe 112. A second arm 224 is coupled to second clamp 216 so that when second clamp 216 is coupled to pipe 112, second arm 224 forms a second arm angle 292 between second arm 224 and water pipe 112. First arm angle 290 and second arm angle 292 have values of about 40 degrees in this embodiment. First and second arm angle 290 and 292 can have values that range from about 30 degrees to about 120 degrees. First arm angle 290 and second arm angle 224 having values of between 30 and 120 degrees has been found to be useful in stabilizing pipe 112 in ground 118. In some embodiments, first arm angle 290 and second arm angle 292 have different angular values.

FIG. 7 shows a close-up view of the clamps and arm connections of an embodiment of a pipe stabilization apparatus 310. Pipe stabilization apparatus 310 is the same as pipe stabilization apparatus 110 except first and second arm 322 and 324 are threaded onto nuts coupled to first and second clamp 314 and 316 instead of being welded. Pipe stabilization apparatus 310 is replacing pipe stabilization apparatus 110 on pipe 112 in the embodiment shown in FIG. 7.

Pipe stabilization apparatus 310 includes a first stabilization arm assembly 382, a second stabilization arm assembly 384, and a clamp coupler 320. First stabilizer arm assembly 382 includes first saddle clamp 314 and first arm 322. Second stabilization arm assembly 384 includes second saddle clamp 316 and second arm 324. The distal ends of first and second arm 322 and 324 are not shown for clarity of coupler 320 and the connections between first and second arm 322 and 324 and first and second clamps 314 and 316.

First saddle clamp 314 includes a first threaded nut 342 coupled to a first saddle clamp outer surface 346. First arm 322 is threaded at first arm proximal end 330. First arm 322 is coupled to first saddle clamp 314 by threadably coupling first arm proximal end 330 to first threaded nut 342. First arm 322 is perpendicular to a first saddle clamp tangent line 350 in this embodiment, but this is not meant to be limiting. Saddle clamp tangent line 350 is a line tangential to first saddle clamp outer surface 346. In some embodiments of pipe stabilization apparatus 310, first arm 322 forms an angle other than 90 degrees between first arm 322 and saddle clamp tangent line 350.

Second saddle clamp 316 includes a second threaded nut 344 that is coupled to a second saddle clamp outer surface 348, as shown in FIG. 7. Second arm 324 is threaded at second arm proximal end 334. Second arm 324 is coupled to second saddle clamp 316 by threadably coupling second arm proximal end 334 to second threaded nut 344.

First and second threaded nut 342 and 344 are welded to first and second saddle clamp 314 and 316, respectively, in this embodiment, but this is not meant to be limiting. First and second threaded nut 342 and 344 can be coupled to first and second saddle clamps 314 and 316, respectively, using any suitable coupling method such as gluing, or forming first and second saddle clamps 314 and 316 with integral threaded nuts. Having first and second arms 322 and 324 threadably coupled to first or second saddle clamps 314 or 316 makes it easy to replace arms 322 and 324 after installation is complete. Clamp coupler 320 includes two bolts 338 and 340 and two nuts 386 and 388 which are used to couple first saddle clamp 314 to second saddle clamp 316 as shown in FIG. 7. Clamp coupler 320 couples first saddle clamp 314 to second saddle clamp 316 with pipe 112 in between. In the embodiment shown in FIG. 7, first and second arm 322 and 324 are colinear in response to first saddle clamp 314 being coupled to second saddle clamp 316. First and second arm 322 and 324 are each formed of straight rebar in this embodiment. In some embodiments, first and second arms 322 and 324 can be formed of other material and/or can be bent or curved. In some embodiments, first and second arm 322 and 324 are not colinear.

FIG. 8 shows an embodiment of a pipe stabilization apparatus 410. Pipe stabilization apparatus 410 is the same as pipe stabilization apparatus 110 except first and second arm 422 and 424 have bends in them. Pipe stabilization apparatus 410 can be used in place of pipe stabilization apparatus 110. Pipe stabilization apparatus 410 is used in place of pipe stabilization apparatus 110 on pipe 112 in the embodiment shown in FIG. 8.

Pipe stabilization apparatus 410 includes a first stabilizer arm assembly 482 and a second stabilizer arm assembly 484 and a clamp coupler 420. First stabilizer arm assembly 482 includes first clamp 414 and first arm 422. Second stabilizer arm assembly 484 includes second clamp 416 and second arm 424.

First arm 422 has a first arm proximal end 430 coupled to first clamp 414. First arm 422 has a first arm distal end 432 opposing first arm proximal end 430, and a first arm bend 474 between first arm proximal end 430 and first arm distal end 432. First arm bend 474 divides first arm 422 into a first arm first section 470 and a first arm second section 472. First arm first section 470 is straight and extends from first arm proximal end 430 to first arm bend 474. First arm second section 472 is straight and extends from first arm bend 474 to first arm distal end 432. First arm bend 474 is a bend in first arm 422 and forms a first arm bend angle 475 between first arm first section 470 and first arm second section 472. First arm bend angle 474 has a value of about 110 degrees in this embodiment, but this is not meant to be limiting. First arm bend angle 474 can range in values from about 30 degrees to about 170 degrees, depending on the geometry of the installation and the amount of stability desired. Having a bend in first arm 422 helps first arm 422 grab onto ground 118 better and makes first arm 422 less likely to move in ground 118, which increases the stability of water pipe 112.

Second arm 424 has a second arm proximal end 434 coupled to second clamp 416. Second arm 424 has a second arm distal end 436 opposing second arm proximal end 434, and a second arm bend 497 between second arm proximal end 434 and second arm distal end 436. Second arm bend 497 divides second arm 424 into a second arm first section 493 and a second arm second section 495. Second arm first section 493 is straight and extends from second arm proximal end 434 to second arm bend 497. Second arm second section 495 is straight and extends from second arm bend 497 to second arm distal end 436. Second arm bend 497 is a bend in second arm 424 and forms a second arm bend angle 498 between second arm first section 493 and second arm second section 495. Second arm bend angle 498 has a value of about 110 degrees in this embodiment, but this is not meant to be limiting. Second arm bend angle 497 can range in values from about 30 degrees to about 170 degrees, depending on the geometry of the installation and the amount of stability desired. Having a bend in second arm 424 helps second arm 424 grab onto ground 118 better and makes second arm 424 less likely to move in ground 118, which increases the stability of water pipe 112.

Clamp coupler 420 includes two bolts, bolt 438 and an opposing bolt not shown, and two nuts which are used with the two bolts to couple first saddle clamp 414 to second saddle clamp 416 with water pipe 112 in between, as shown in FIG. 8. Clamp coupler 420 couples first saddle clamp 414 to second saddle clamp 416 with pipe 112 in between. In the embodiment shown in FIG. 8, first arm first section 470 and second arm first section 493 are colinear in response to first saddle clamp 414 being coupled to second saddle clamp 416. First and second arm 422 and 424 are each formed of rebar in this embodiment. In some embodiments, first and second arms 422 and 424 can be formed of other material and/or can have additional bends or curves in them.

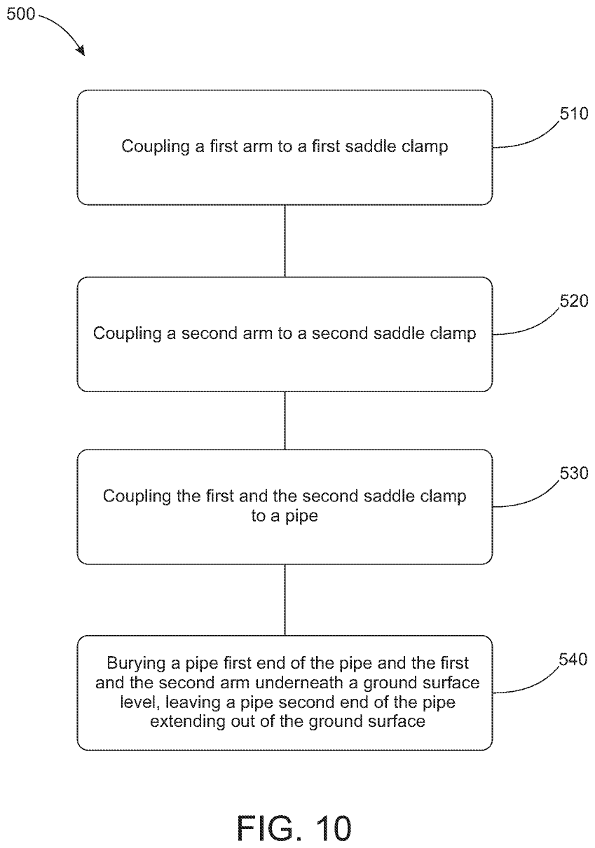

Pipe stabilization apparatus 110 can be used for any types of pipes, not just water pipes. FIG. 9, for example, shows an embodiment of a stabilized pipe system 602, which includes a gas riser pipe 612 and pipe stabilization apparatus 110. FIG. 10 shows a side view of stabilized pipe system 602 and pipe stabilization apparatus 110 as installed in ground 118. Stabilized pipe system 602 is the same as stabilized pipe system 102 except a gas riser pipe system 608 replaces yard water hydrant 108.

Stabilized pipe system 602 includes gas riser pipe system 608 and pipe stabilization apparatus 110, as shown in FIG. 9. Gas riser pipe system 608 includes gas riser pipe 612, a pipe cap 606, and a gas pipe coupler 626. Gas riser pipe 612 is a pipe for transporting gas, with a gas riser pipe first end 654 and a gas riser pipe second end 656 opposing gas riser pipe first end 654. Pipe cap 606 is coupled to gas riser pipe second end 656 in this embodiment. Gas riser pipe second end 656 and pipe cap 606 are above ground surface level 160 of ground 118, and are referred to as a “pipe stub”. Gas riser pipe second end 656 can be coupled to a gas appliance or other gas device which receives the gas from gas riser pipe 612. Gas pipe coupler 626 is coupled to gas riser pipe first end 654. Gas pipe coupler 626 at gas riser pipe first end 654 is coupled to an underground gas line 662, which delivers gas to gas riser pipe 612. An upper portion 615 of gas riser pipe 612 extends from ground surface level 160 to gas riser pipe second end 656. Upper portion 615 extends essentially vertically out of ground 118 in this embodiment, but this is not meant to be limiting. A lower portion 613 of gas riser pipe 612 extends from ground surface level 160 to gas riser pipe first end 654, and is buried underground. Pipe stabilization apparatus 110 is coupled to lower portion 613 of gas riser pipe 612 such that pipe stabilization apparatus 110 is buried in ground 118, as shown in FIG. 9. Gas line 662, gas pipe coupler 626, gas riser pipe first end 654, lower portion 613 of gas riser pipe 612, and pipe stabilization apparatus 110 are buried in ground 118 below ground surface level 160. Upper portion 615 of gas riser pipe 612, gas riser pipe second end 656, and gas pipe cap 606 extend above ground surface level 160 of ground 118.

Pipe stabilization apparatus 110 described herein stabilizes gas riser pipe 612 in ground 118 so that forces or stress put on gas riser pipe 612 from aboveground do not transfer as stress on the underground connections. Pipe stabilization apparatus 110 is attached to gas riser pipe 612 so that once installation of stabilized pipe system 602 is complete, pipe stabilization apparatus 110 is buried under ground surface level 160 in ground 118 with lower portion 613 of gas riser pipe 612 and gas pipe coupler 626, see FIG. 9. Forces and stress applied to the aboveground elements of stabilized pipe system 602 do not transfer to the underground gas pipe connections because pipe stabilization apparatus 110 holds gas riser pipe 612 in place in ground 118. Pipe stabilization apparatus 110 is also useful in holding gas riser pipe 612 in place as stabilized pipe system 602 is installed.

FIG. 9 shows a side view of stabilized pipe system 602 including gas riser pipe 612 and pipe stabilization apparatus 110, after installation is complete. Pipe stabilization apparatus 110 holds gas riser pipe 612 stable in ground 118 just as it does with water pipe 112.

Pipe stabilization apparatus 110 includes first and second clamp 114 and 116, clamp coupler 120, and first and a second arm 122 and 124, as explained earlier and illustrated in FIG. 1 through FIG. 5. Pipe stabilization apparatus 210, 310, or 410 can also be used with gas riser pipe 612 in place of pipe stabilization apparatus 110. Gas riser pipe 612 can be substituted for water pipe 112 in the embodiments shown in FIG. 6 and FIG. 8.

First and second arm 122 and 124 are coupled to gas riser pipe 612 using first and second clamps 114 and 116, and clamp coupler 120. First arm 122 includes a first arm proximal end 130 and a first arm distal end 132 opposing first arm proximal end 130, see FIG. 9. First arm proximal end 130 is coupled to first clamp 114. First arm proximal end 130 of first arm 122 is coupled to first clamp 114 such that when first clamp 114 is coupled to gas riser pipe 612, first arm 122 extends perpendicular to gas riser pipe 612.

Second arm 124 includes a second arm proximal end 134 and a second arm distal end 136 opposing second arm proximal end 134. Second arm proximal end 134 is coupled to second clamp 116. Second arm proximal end 134 of second arm 124 is coupled to second clamp 116 such that when second clamp 116 is coupled to gas riser pipe 612, second arm 124 extends perpendicular to gas riser pipe 612. First and second arm 122 and 124 are perpendicular to gas riser pipe 612 once first and second clamp 114 and 116 are coupled to gas riser pipe 612, in this embodiment, but this is not meant to be limiting. In some embodiments, first and second arm 122 or 124 form an angle other than 90 degrees between first or second arm 122 or 124, and gas riser pipe 612. See, for example, FIG. 6 and the accompanying description.

First arm 122 is coupled to an outer surface of first clamp 114. First arm 122 is coupled to an outer surface of first clamp 114 so that when first clamp 114 is coupled to gas riser pipe 612 with an inner surface of first clamp 114 against gas riser pipe 612, first arm 122 extends outwards perpendicularly from gas riser pipe 612. In this embodiment, first arm 122 is coupled to first clamp 114 such that first arm 122 is perpendicular to a tangent line of first clamp 114. First arm proximal end 130 of first arm 122 is welded to first clamp 114 in this embodiment, but this is not meant to be limiting. First and second arm 122 and 124 can be coupled to first and second clamp 114 and 116 using any type of coupling. See, for example, FIG. 4 and the accompanying description. First arm 122 is coupled to first clamp 114 about halfway between the two ends of the elongate bar forming first clamp 114, in this embodiment, but this is not meant to be limiting. First arm 122 can be coupled to first clamp 114 at many different locations along first clamp 114.

Second arm 124 is coupled to an outer surface of second clamp 116. Second arm 124 is coupled to an outer surface of second clamp 116 so that when second clamp 116 is coupled to gas riser pipe 612 with an inner surface of second clamp 116 against gas riser pipe 612, second arm 124 extends outwards perpendicularly from gas riser pipe 612. In this embodiment, second arm 124 is coupled to second clamp 116 such that second arm 124 is perpendicular to a tangent line of second clamp 116. Second arm 124 is welded to second clamp 116 in this embodiment, but this is not meant to be limiting. Second arm 124 is coupled to second clamp 116 about halfway between the two ends of the elongate bar forming second clamp 116 in this embodiment, but this is not meant to be limiting. Second arm 124 can be coupled to second clamp 116 at many different locations along second clamp 116.

With first arm 122 coupled to first clamp 114 and second arm 124 coupled to second clamp 116, first and second clamp 114 and 116 are coupled to gas riser pipe 612 using clamp coupler 120. Clamp coupler 120 includes two bolts 138 and 140 and two nuts 186 and 188, see FIG. 3. First clamp 114 is coupled to second clamp 116 using clamp coupler 120, with gas riser pipe 612 in between. It is to be understood that clamp coupler 120 can be replaced with many different types of couplers for coupling first and second clamp 114 and 116 to gas riser pipe 612.

Clamp coupler 120 couples first and second clamp 114 and 116, and first and second arm 122 and 124, to gas riser pipe 612. First and second arm 122 and 124 are colinear in the embodiment shown in FIG. 9, but this is not meant to be limiting. In some embodiments, first and second arm 122 and 124 are not colinear, see FIG. 6 and the accompanying description, for example.

In the embodiment shown in FIG. 9, clamp coupler 120 couples both first and second clamp 114 and 116 to gas riser pipe 612. In some embodiments, first clamp 114 and second clamp 116 are not coupled to gas riser pipe 612 using the same clamp coupler. In some embodiments, first clamp 114 and first arm 122 are coupled to gas riser pipe 612 with a first coupler at a first location on gas riser pipe 612, and second clamp 116 and second arm 124 are coupled to gas riser pipe 612 using a second coupler at a second location on gas riser pipe 612. The first coupler and the second coupler can couple first and second clamp 114 and 116 to gas riser pipe 612 in different locations on pipe 112. This construction can be useful if there are obstructions in the ground, for example, that make it difficult for first arm 122 and second arm 124 to be colinear in the installation.

FIG. 10 illustrates a method 500 of stabilizing a pipe. Method 500 includes an act 510 of coupling a first arm to a first saddle clamp. Method 500 includes an act 520 of coupling a second arm to a second saddle clamp. In some embodiments, the first and second saddle clamps are not saddle clamps, but other forms of clamps.

Method 500 includes an act 530 of coupling the first and the second saddle clamp to a pipe. The pipe has a pipe first end and a pipe second end opposing the pipe first end. Coupling the first and the second saddle clamps to the pipe couples the first and the second arm to the pipe. In some embodiments, the first arm and the second arm are colinear in response to the first and the second saddle clamps coupling the first and the second arm to the pipe. In some embodiments, the first arm and the second arm are perpendicular to the pipe in response to the first and the second saddle clamps coupling the first and the second arm to the pipe.

Method 500 includes an act 540 of burying the pipe first end and the first and the second arm underground, under a ground surface level, leaving the pipe second end extending above the ground surface level. Burying the first and the second arm (which are coupled to the pipe) underground stabilizes the pipe. Burying the first and the second arm underground make the first and the second arm and the buried portion of the pipe difficult to move. In some embodiments, a distal end of either the first or the second pipe is embedded in a concrete slab to make the arm even more immovable and the pipe more stable.

In some embodiment, the pipe is a pipe of a yard water hydrant and has a valve coupled to the pipe first end and a spigot coupled to the pipe second end. In some embodiments the pipe first end is coupled to an underground water line or an underground water source. Burying the first and the second arm underground stabilizes the pipe so that pipe movement is limited and reduces the chances of forces on the pipe causing breakage of the pipe or underground connections of the pipe.

In some embodiments, the pipe is a gas riser pipe and has a gas pipe coupler coupled to the pipe first end. In some embodiments a pipe cap is coupled to the gas riser pipe second end. In some embodiments the pipe first end is coupled to an underground gas line or an underground gas source. Burying the first and the second arm underground stabilizes the gas riser pipe so that gas riser pipe movement is limited and reduces the chances of forces on the pipe causing breakage of the gas riser pipe or underground connections of the gas riser pipe.

Disclosed is a method of stabilizing a pipe using a pipe stabilization apparatus where the arms have been pre-attached to the clamps. The method includes an act of coupling a first and the second clamp to a pipe, where the first clamp has a first arm coupled to it, and the second clamp has a second arm coupled to it. The pipe has a pipe first end and a pipe second end opposing the pipe first end. Coupling the first and the second clamps to the pipe couples the first and the second arm to the pipe. In some embodiments, the first arm and the second arm are colinear in response to the first and the second clamps being coupled to the pipe. In some embodiments, the first arm and the second arm are perpendicular to the pipe in response to the first and the second clamps being coupled to the pipe.

The method includes an act of burying the pipe first end and the first and the second arm underground, leaving the pipe second end extending aboveground, above the ground surface level. Burying the first and the second arm (which are coupled to the pipe) underground stabilizes the pipe. Burying the first and the second arm underground make the first and the second arm and the buried portion of the pipe difficult to move. In some embodiments, a distal end of either the first or the second pipe is embedded in a concrete slab to make the arm even more immovable and the pipe more stable.

In some embodiments, the pipe is a pipe of a yard water hydrant and has a valve coupled to the pipe first end and a yard water hydrant spigot coupled to the pipe second end. In some embodiments the pipe first end is coupled to an underground water line or an underground water source. Burying the first and the second arm underground stabilizes the pipe so that pipe movement is limited and reduces the chances of forces on the pipe causing breakage of the pipe or underground connections of the pipe.

In some embodiments, the pipe is a gas riser pipe and has a gas pipe coupler coupled to the pipe first end. In some embodiments a pipe cap is coupled to the gas riser pipe second end. In some embodiments the pipe first end is coupled to an underground gas line or an underground gas source. Burying the first and the second arm underground stabilizes the gas riser pipe so that gas riser pipe movement is limited and reduces the chances of forces on the pipe causing breakage of the gas riser pipe or underground connections of the gas riser pipe.

Embodiments of a pipe stabilization apparatus have been described that are used to stabilize a plumbing or gas pipe that extends from the ground. The pipe stabilization apparatus includes a first arm coupled to a first clamp, and a second arm coupled to a second clamp. The first and the second clamp are coupled to each other with the pipe in between so that the first and the second clamp and the first and the second arm are coupled to the pipe. When a first end of the pipe is buried, along with the two clamps and the two arms, the arms clamped to the pipe stabilize the pipe so that the part of the pipe buried underground is less likely to move. The pipe can be the pipe of a yard water hydrant, for example, and have a valve on a pipe first end that is buried, and a yard water hydrant spigot on a pipe second end that is not buried. With the yard water hydrant pipe first end coupled to a water line or other underground water source, the yard water hydrant spigot is used to deliver water aboveground. The first and second arms clamped to the pipe reduce the amount of stress and breakage on the underground water connections. The pipe can be a gas riser pipe with a first end coupled to a gas line underground.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A pipe stabilization apparatus comprising:
a first saddle clamp;
a first threaded nut coupled to a first saddle clamp outer surface;
a second saddle clamp;
a second threaded nut coupled to a second saddle clamp outer surface;
a first arm threadably coupled to the first threaded nut;
a second arm threadably coupled to the second threaded nut; and
a pair of bolts coupling the first saddle clamp to the second saddle clamp.

2. The pipe stabilization apparatus of claim 1, wherein the first arm is perpendicular to a first saddle clamp tangent line.

3. The pipe stabilization apparatus of claim 1, wherein the first arm is colinear with the second arm in response to the first saddle clamp being coupled to the second saddle clamp.

4. The pipe stabilization apparatus of claim 1, wherein the first and the second arms are each formed of straight rebar.

5. The pipe stabilization apparatus of claim 1, wherein the first arm has a first arm elbow forming a first arm bend angle between a first arm first section and a first arm second section.

6. The pipe stabilization apparatus of claim 1, further comprising a stability attachment coupled to the first arm.

7. A method of stabilizing a pipe, the method comprising:
coupling a first arm to a first saddle clamp;
coupling a second arm to a second saddle clamp;
coupling the first and the second saddle clamps to the pipe, wherein the pipe has a pipe first end and a pipe second end; and
burying the pipe first end, the first arm and the second arm below a ground surface level, leaving the pipe second end extending above the ground surface level.

8. The method of claim 7, further comprising coupling the pipe first end to a water line, wherein the pipe has a spigot coupled to the pipe second end.

9. The method of claim 7, further comprising coupling the pipe first end to a gas line.

10. The method of claim 7, wherein the first and the second arms are perpendicular to the pipe.

11. The method of claim 7, further comprising embedding a first arm distal end in a buried concrete slab.

12. A stabilized pipe system comprising:
a pipe having a pipe first end and a pipe second end opposing the pipe first end, wherein the pipe first end is buried below a ground surface level and the pipe second end is above the ground surface level; and
a pipe stabilization apparatus comprising:
a first clamp coupled to the pipe below the ground surface level;
a first arm coupled to the first clamp;
a second clamp coupled to the pipe below the ground surface level;
and
a second arm coupled to the second clamp.

13. The stabilized pipe system of claim 12, further comprising:
a first threaded nut coupled to the first clamp, wherein the first nut threadably couples the first arm to the first clamp; and
a second threaded nut coupled to the second clamp, wherein the second nut threadably couples the second arm to the second clamp.

14. The stabilized pipe system of claim 12, wherein the first clamp is coupled to the second clamp using a clamp coupler, with the pipe between the first clamp and the second clamp.

15. The stabilized pipe system of claim 12, wherein the first and second arms are perpendicular to the pipe.

16. The stabilized pipe system of claim 12, further comprising a concrete slab buried below the ground surface level, wherein a first arm distal end is embedded in the concrete slab.

17. The stabilized pipe system of claim 12, wherein the first and the second arms are straight.

18. The stabilized pipe system of claim 12, wherein the first and the second arms are colinear.

19. The stabilized pipe system of claim 12, further comprising a stability attachment coupled to the first arm.

20. The stabilized pipe system of claim 12, wherein the first arm has a first arm elbow forming a first arm bend angle between a first arm first section and a first arm second section.
